(19) United States
(12) Patent Application Publication
(10) Pub. No.: US 2020/0040972 A1
(43) Pub. Date: Feb. 6, 2020

(54) SLIDE BLOCK ASSEMBLY

(71) Applicant: TRICORE CORPORATION, Taichung City (TW)

(72) Inventor: Yu-Zhi HUANG, Taichung City (TW)

(21) Appl. No.: 16/262,083

(22) Filed: Jan. 30, 2019

(30) Foreign Application Priority Data
Aug. 3, 2018 (TW) 107210660

(51) Int. Cl. F16H 25/24

(52) U.S. Cl. CPC F16H 25/24; F16H 2025/204

(57) ABSTRACT

A slide block assembly mounted on a thread rod having a slide block and an entraining element. The slide block is coupled up by two slide units with an inner bore of spiral surface for screwing connection. The entraining element is deployed outside of the slide block for restraining the slide units in help of solving the problem as block seizing by slightly enhancing torque onto the block, so as to create a block gap leading an automatic consequence of slide block's restoration from deviation resulted from an inappropriate screw between the thread rod and the thread bore.

### BACKGROUND OF THE INVENTION

### Field of the Invention

This invention relates to a slide block assembly and, more specifically, to a structure for preventing seizing of a linear actuator.

### Description of the Related Art

A linear actuator may shift a rotary motion into a linear movement which basically consists of a motor drive, a screw nut and a thread rod. The thread rod is mounted by a screw nut, and the screw nut is driven by the motor so as to activate a linear movement.

Traditional linear actuator may happen to have a problem of block seizing when being shaking or enforcing led by an inappropriate connection between the screw nut and the thread rod on the inner spiral part, and the solution usually is decomposing and reassembling the screw unit, however, it unavoidably aggregates the difficulty for repairing especially when the screw nut of the linear actuator has a complicated mechanism (for example with balls or rollers installation) or when the linear actuator is applied to a micro mechanism.

In view of this, the inventors had been endeavoring and figuring out an improvement to cope with foregoing problem resulted from default designs tag along with miscellaneous inconveniences.

### SUMMARY OF THE INVENTION

Based on that, this invention provides a slide block assembly, mounted on a thread rod for preventing seizing problem, which comprises a slide block and an entraining element, wherein the slide block having at least two slide units for coupling up a thread bore as thread rod connection is girdled by the entraining element for restraining at least two slide units.

By changing the assembling structure from screwing a thread rod into the slide block to restraining an entraining element 30 (such as a curve spring clip or a U-shaped resilient sheet) onto the slide block. When the seizing problem is happened, user can input a slight enforcing torque onto the thread rod for creating a block gap and leading the slide block's automatic restoration from deviation. This invention may be exempted from the situation of operational intervene caused by block's seizing.

Besides, considering the thread rod's force enduring and slippery preventing while restoration, the slide units may be equipped with corresponding grooves to secure the U-shape entraining element; specifically, the slide units may have corresponding grooves to accommodate the U-shaped entraining element with a loop, two arms and the open ends.

Preferably, the slide block may be equipped with a guide slot or at least a part of the guide slot of the slide units for installation of a guide rod.

### BRIEF DESCRIPTION OF THE DRAWINGS

FIG. 1 is an exploded view of the embodiment of this invention.

FIG. 2 is a schematic diagram illustrating the structure of the embodiment of this invention.

FIG. 3 is a cross-sectional view of the embodiment of this invention.

### DETAILED DESCRIPTION OF PREFERRED EMBODIMENTS

To be further illustrate the implementation, the structure and the performance of this invention thereof, it will be best understood from the following description of specific embodiments when read in connection with the accompanying drawings.

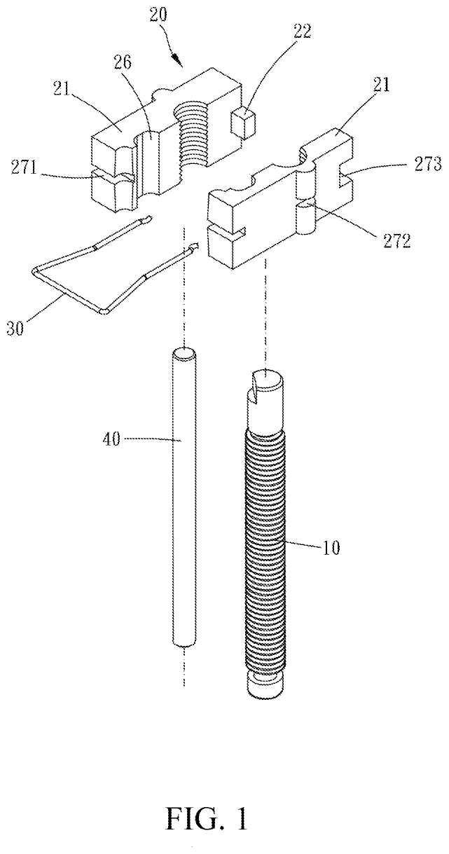

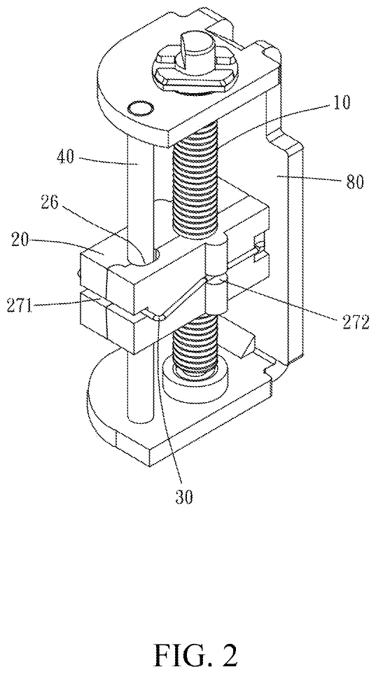

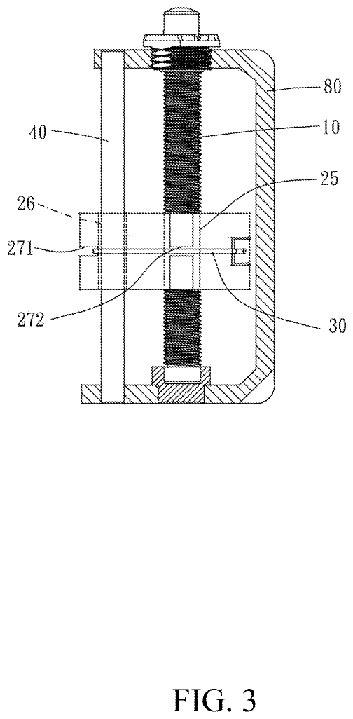

The slide block assembly for preventing seizing problem comprises a slide block 20 and an entraining element 30, wherein the slide block 20 is combined with two slide units 21, and the slide units 21 couples up a thread bore 25 on the inner wall as for screwing onto a thread rod 10 and for transferring the thread rod's rotating motion to a linear movement. An entraining element 30 is deployed outside of the slide block 20 as for restraining the slide units 21 and for securing the structure of the thread bore 25 as shown in FIGS. 1 to 3.

By changing the traditional structure of the slide block assembly from screwing a thread rod 10 into a slide block to restraining by an entraining element 30 onto the slide block. When the seizing problem is happened, an enforcing torque input onto the thread rod 10 which arouses a reaction force to resist the resilience of the entraining element 30 and creates a block gap to lead the slide block's automatic restoration from deviation as a result of leading a correct connection, and preventing an operational interruption between the thread rod 10 and the thread bore 25.

In operation, the technicians in related arts may deploy balls and rollers onto the slide block 20 as per the requirement.

In the embodiment of this invention, the entraining element 30 is a U-shaped elastic unit 30; to be more specific, it may be a U-shaped spring clip or a U-shaped resilient sheet as well. The U-shaped entraining element 30 restrain the slide block 20 by resting its loop onto the cliff of the slide unit 21 and by two arms holding onto two sidewalls of the slide unit 21.

In the embodiment of this invention, two open ends of the U-shaped entraining element 30 prepares hooks for inserting into the positioning groove 273. Besides, the entraining element 30 further equips a curve structure with wavy arms for restraining on the sidewalls of the slide units 21; specifically, the two arms may bend inwardly to the positioning groove 272 on the sidewalls located near the thread bore 25 for a better restraining purpose. While the structure of the entraining element of this invention is an exemplification and may not be used to limit the spirit of this invention.

The embodiment of this invention adopts a pair of slide units 21 to compose a slide block, while the quantity of the slide units 21 may not be limited and may be changeable depending on the assembling situation.

In the embodiment of this invention, the slide units 21 equip a pair of compatible blocks 22 mainly contouring the U-shaped entraining element 30 from its loop to the open ends, on the cliff of the slide units 21 indents a first positioning groove 271 for accommodating the loop of the U-shaped entraining element 30, on the sidewalls separately protrude two second positioning grooves 272 right above the thread bore 25 for adapting two arms of the U-shaped entraining element 30. Moreover, on the clamp ends of the slide units 21 separately yields two third positioning grooves 273 for isolately decking two open ends of the U-shaped entraining element 30 which are designated to endure the forcing of the thread rod and to assist the restoration of the slide unit 21 without slippery.

In the embodiment of this invention, the slide block 20 includes a guide slot 26 for steady installing a guide rod 40 to prevent the rotation of slide block 20. To be more specifically, the installation of the slide block assembly initiates from inserting the thread rod 10 into the guide slot 26 and from the thread rod screwing into the thread bore 25 in a sequence fashion, and finishes by their landing on a positioning deck 80 with a consequence of leading a linear movement of the slide units 21. The guide slot 26 may be attached by an indent fraction of the slide unit 21, or may as well be coupled up by a compatible indent aperture with a protrude block positioned deployed on the sidewalls of the slide block 20. The deployment of the guide slot 26 is optional on condition that the slide block may operate steady without rotating when the thread rod is spinning under pressure.

What is claimed is:

1. A slide block assembly mounted on a thread rod comprises:
a slide block having two slide units coupled up a thread bore for screwing on the thread rod; and
an entraining element girdled on the outside of the slide block for restraining two slide units.

2. A slide block assembly as defined in claim 1, wherein the slide units are composed of two compatible blocks.

3. A slide block assembly as defined in claim 1, wherein the slide block has a guide slot.

4. A slide block assembly as defined in claim 3, wherein the two slide units compose the guide slot.

5. A slide block assembly as defined in claim 1, wherein the slide block has at least one positioning groove for accommodating the entraining element.

6. A slide block assembly as defined in claim 1, wherein the entraining element is curve or U shape.

7. A slide block assembly as defined in claim 1, wherein the entraining element is a U-shaped elastic unit, and the slide unit have two first positioning grooves for accommodating a loop of the entraining element.

8. A slide block assembly as defined in claim 7, wherein the sidewalls of the slide units are equipped with two second positioning grooves for separately accommodating two arms of the entraining element.

9. A slide block assembly as defined in claim 7, wherein the slide units is deployed with two third positioning grooves away from the first positioning groove, and the open ends of the entraining element are equipped with two hooks for separately inserting into the third positioning grooves.
